(19) United States
(12) Patent Application Publication
(10) Pub. No.: US 2026/0277771 A1
(43) Pub. Date: Sep. 17, 2026

(54) SCRIPT EXECUTION ENGINE(S) FOR APPLICATION AUTOMATION

(71) Applicant: GOOGLE LLC, Mountain View, CA (US)

(72) Inventors: Mugurel-Ionut Andreica, Adliswil (CH); Luis Dorelli, London (GB); Rupika Srivastava, London (GB); Zygimantas Bruzgys, Zurich (CH); Samuel Valenzuela Perez, Zurich (CH); Andrei Giurgiu, Zurich (CH); Bogdan Prisacari, Adliswil (CH)

(21) Appl. No.: 19/077,919

(22) Filed: Mar. 12, 2025

(51) Int. Cl. G06F 11/3604; G06F 8/30

(52) U.S. Cl. CPC G06F 11/3612; G06F 8/30

(57) ABSTRACT

Various implementations include in-app automation to automate the execution of tasks in a user application by a virtual assistant and/or a generative model. In some implementations, a script execution engine is integrated directly into the user application, where the script execution engine executes script(s) to perform task(s) in the user application without extensive use of developer-implemented application programming interfaces. In many implementations, a given script (composed of a sequence of low level user interface actions) is automatically generated using various techniques. In various implementations, the script execution engine and/or corresponding scripts can be automatically integrated into the user application when the application is uploaded to an application store (e.g., published) and/or can be integrated via a software development kit by the developer of the user application.

### BACKGROUND

Humans may engage in human-to-computer dialogs with interactive software applications referred to herein as “automated assistants” (also referred to as “chatbots,” “interactive personal assistants,” “intelligent personal assistants,” “personal voice assistants,” “conversational agents,” etc.). Automated assistants typically reply upon a pipeline of components for interpreting and responding to natural language (NL) based inputs received during a dialog session. Generative models (GMs), such as large language models (LLMs), are particular types of machine learning models that are trained on enormous amounts of diverse data and that can perform various natural language processing (NLP) tasks.

Automating the execution of tasks inside a given user application is difficult for an automated assistant. Additionally, task automation inside the given user application typically requires a developer of the given user application to implement a set of application programming interfaces (APIs). However, developer implementation of APIs is sparse resulting in capability gaps for automated assistants performing tasks for a user in a given user application.

### SUMMARY

Techniques described herein are directed towards the in-application (in-app) automation of task execution in user applications by an automated assistant and/or a generative model. As described herein, “in-app automation” refers to the required changes in the target user application, where the changes should be made with low and/or zero developer input. A script execution engine can be included in each user application, where the script execution engine includes one or more scripts, which when executed by the engine, perform user application tasks. In some implementations, a given script corresponds to a sequence of application automation actions mapping to one or more high level user application tasks such as adding items to a list, playing audio, playing video, sending a message, searching inside a user application, one or more additional or alternative tasks, and/or combinations thereof. The API surface of the user application can be expanded based on executing scripts with the script execution engine. Executing a script in a user application, via the script execution engine, enables the automated assistant and/or generative model to interact with the user interface of the user application via tapping, scrolling, entering text, etc.

The script execution engine is integrated within a given user application. In some implementations, the script execution engine can be automatically injected into the user application (with the developer consent) when the developer uploads the user application and/or an update to the user application to an application store. For example, the script execution engine can be injected into “Hypothetical User Application” automatically when a developer uploads “Hypothetical User Application” and/or an update to “Hypothetical User Application” to a respective application store. As another example, the script execution engine can be injected into “Hypothetical User Application” automatically when a developer requests (e.g., via an API provided by the user of “Hypothetical User Application” to the developer) that the script execution engine be injected into “Hypothetical User Application.” In some versions of those implementations, the user of “Hypothetical User Application” can opt-in to have the script execution engine included in “Hypothetical User Application.” In some other implementations, the script execution engine can be included in the user application given a software development kit (SDK), where the application developer includes the script execution engine during the development of the user application. For example, the developer can integrate the script execution engine and/or one or more executable scripts into “Hypothetical User Application” during development of the application using the SDK.

In some implementations, scripts provide advantages over machine learning (ML) models for in-app automation. For example, the execution of a script can be verified (e.g., the script can be made open source). In contrast, ML models are generally opaque and cannot be verified. Additionally or alternatively, script execution can run fully inside a user application (e.g., by integrating the script execution engine with the user application). In contrast, integrating a large ML model with a user application increases the size of the application (e.g., when the model is directly integrated), the latency in performing tasks via the application (e.g., when the application must communicate with the ML model stored remotely from the user application and/or remotely from the client device), and/or the overhead required by the developer. Furthermore, script execution fully inside the application does not require transmitting application data (i.e., potentially sensitive user data) to an outside service (such as when a large ML model is available to the user application as a service).

Additionally or alternatively, the system can automatically generate one or more scripts which can be executed by the script execution engine to automatically perform application tasks. In some implementations, ML models can be used in generating the scripts, where the ML models are only used in script generation and are not called by the scripts during execution of the script. For example, an existing ML model (such as an end-to-end ML model) can be used, adapted, and/or retrained for use in automatically generating scripts. Additionally or alternatively, a custom ML model can be trained for use in automatically generating scripts. To automatically generate one or more scripts, the system can record traces of actions performed by the script execution engine using one or more ML models as demonstrators. One or more generic scripts can be generated based on the recorded traces.

For example, one or more ML models can process a full screen representation of the user application and a semantic representation of the task to generate output indicating the next low level action for the user application. In some other implementations, the one or more ML models can process the full screen representation of the user application and a natural language description of the task and/or the next step of the task to generate output indicating the next low-level action for the user application. The system can use a variety of full screen representations including a view hierarchy, an accessibility tree, a screen shot capturing the user application, one or more additional or alternative representations of the user application, and/or combinations thereof.

Additionally or alternatively, the system can include a set of pre-defined generic scripts which can be used to execute tasks in multiple user applications. In some implementations, a pre-defined generic script includes one or more horizontal semantic annotators which are not application specific. A full and/or partial screen representation of the user application can be processed by the annotator to generate one or more semantic annotations. For example, a full and/or partial screen representation of the user application can be processed using an icon annotator to annotate one or more icons in the user application.

In some implementations, the system can test a set of predefined specific scripts to see which (if any) of the predefined specific scripts work with the user application. The specific scripts can be pre-defined per task, can be working scripts for the previous version of the application, etc. Additionally or alternatively, one or more scripts can be generated based on user application exploration and/or application crawling to identify important states inside a given user application (e.g., named states) and ways to get to those states.

Accordingly, implementations described herein are directed towards in-app automation where a script execution engine is integrated into a user application. Conventional application automation techniques require the developer to integrate and/or implement a set of application programming interfaces (APIs) for automating application tasks. This leads to sparse API implementations by developers, resulting in capability gaps between user applications and automated assistants. In contrast, implementations described herein require minimal and/or zero developer actions to integrate a script execution engine into a user application. Additionally or alternatively, the scripts can be automatically generated by the system described herein, without developer intervention.

The above description is provided as an overview of only some implementations disclosed herein. These and other implementations are described in more detail herein, including in the detailed description and the claims.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example of in-app automation in accordance with various implementations.

FIG. 2 illustrates an example of automatic script generation for a user application in accordance with various implementations.

FIG. 3 illustrates an example of script execution engine code injection in accordance with various implementations.

FIG. 4 illustrates an example of automatically generating scripts for a user application in accordance with various implementations.

FIG. 5 is a flowchart depicting an example process for in-app automation in accordance with various implementations.

FIG. 6 is a flowchart depicting an example process of a script execution engine executing a script to perform an application task in accordance with various implementations.

FIG. 7 illustrates an example computing device in accordance with various implementations.

FIG. 8 illustrates another example computing device in accordance with various implementations.

FIG. 9 illustrates an example architecture of a computing device.

### DETAILED DESCRIPTION

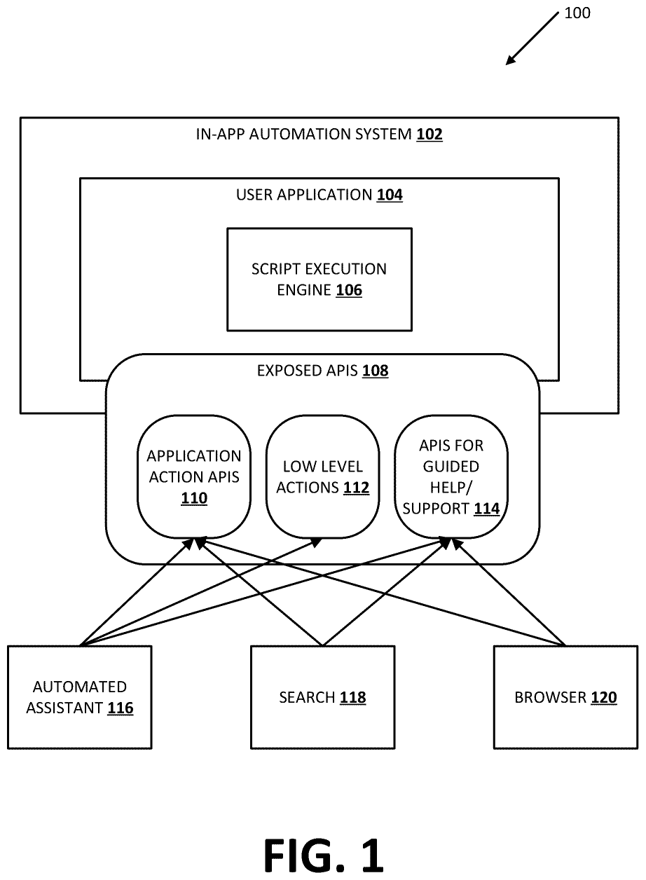

Turning now to the figures, FIG. 1 illustrates an example 100 of in-app automation in accordance with various implementations. FIG. 1 includes an in-app automation system 102, a user application 104, a script execution engine 106, and exposed application programming interfaces (APIs) 108. In the illustrated example, the in-app automation system 102 uses user interface (UI) based application automation. In-app automation refers to the fact that the target user application 104 requires changes, where the changes are required with limited or minimal user interaction. In some implementations, the user application 104 is a first party (1P) application. Additionally or alternatively, the user application 104 can be a third party (3P) application.

Script execution engine 106 is integrated in user application 104. In some implementations, the script execution engine 106 is automatically injected into the user application 104 (with the developer consent) when the developer uploads the user application 104 and/or an update to the user application to the application store. Additionally or alternatively, the script execution engine 106 can be included in the user application 104 given a software development kit (SDK), where the application developer includes the script execution engine 106 during the development of user application 104.

In some implementations, the script execution engine 106 is injected/added into the user application 104 for running UI automation scripts. However, the size of the script execution engine should be minimal to not impact the performance (e.g., latency, throughput, etc.) of the user application 104. Furthermore, the size limitations limit or prevent the full integration of complex machine learning (ML) models into the in-app automation system.

In some implementations, the script execution engine 106 runs inside the user application 104. This gives the script execution engine 106 access to a full view (e.g., a full view hierarchy, etc.) for what is displayed by the user interface of the user application 104, including text, resource identification data, attributes, etc.) which can be used by the script execution engine 106 to identify elements within the user interface of the user application 104 to act on. Additionally or alternatively, the script execution engine 106 can act directly on UI elements (e.g., tap, set text, scroll, etc.) of the user interface of the user application 104 without the need for external APIs.

In some implementations, the script execution engine 106 can fetch a screenshot of the current screen of the user application 104 and process the screenshot using one or more annotators (e.g., screenshot-based annotators), where the annotators can then be mapped back to UI elements in the view hierarchy.

In some implementations, the implementation of the script execution engine 106 includes a background execution thread which maintains the state of the script (e.g., the current step during execution). In some versions of those implementations, the background execution thread can post the next action to be performed on a UI thread (e.g., checking UI-based conditions and, if met, performing actions on the UI elements). If the UI-based conditions are not met, the background execution thread can retry the action and/or abandon the action after too many failures and/or after a threshold duration of time has passed with no progress made with regards to advancing the script execution.

In some implementations, the in-app automation system 102 includes one or more exposed APIs 108 of the user application 104. For example, application action APIs 110 can include intent related APIs (e.g., relating to deeplinks, one or more remote actions, etc.). Low level actions 112 APIs can include APIs relating to tapping, setting text, scrolling down, scrolling up, etc. Additionally or alternatively, APIs for guided help/support 114 can include APIs relating to deeplinks.

Automated assistant 116 can access a variety of types of exposed APIs 108 including application action APIs 110, low level actions 112, APIs for guided help/support 114, one or more additional or alternative types of APIs of user application 104, and/or combinations thereof. In contrast to automated assistant 116, a search function 118 generally can access application APIs 110 and APIs for guided help/support 114 (but not low level actions 112). Similarly, a browser 120 generally can access application APIs 110 and APIs for guided help/support 114 (but not low level actions 112).

In some implementations, low level actions (such as those exposed by low level actions APIs 112) can include tapping, scrolling, setting text, adding items to a list, playing music, playing video, sending a message, buying an item, changing settings in the user application, searching a user application, additional or alternative actions, and/or combinations thereof.

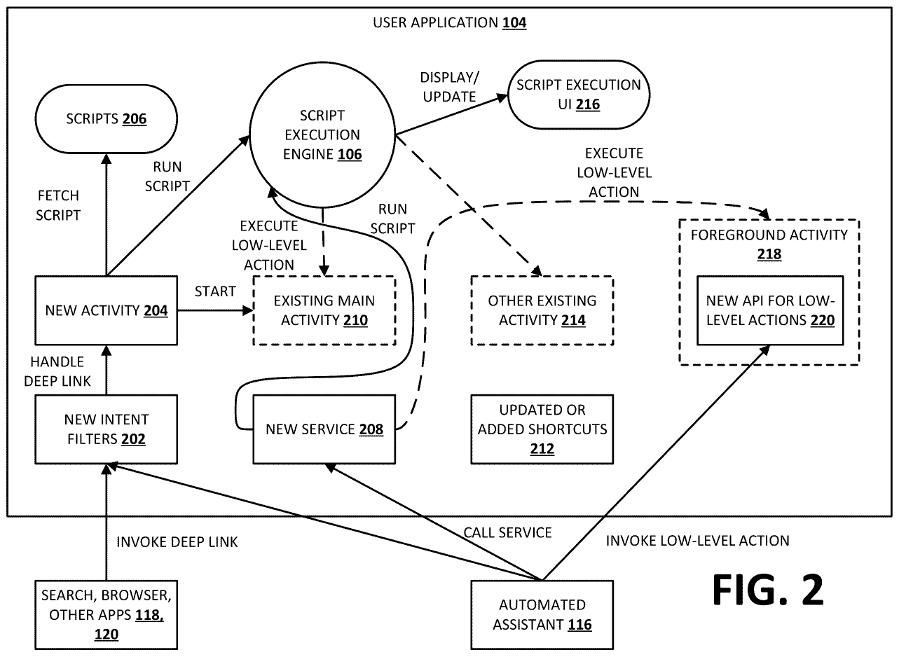

FIG. 2 illustrates an example 200 of automatic script generation for a user application in accordance with various implementations. Example 200 illustrates changes inside the user application for in-app automation. FIG. 2 includes user application 104, script execution engine 106, automated assistant 116, search, browser, and/or other applications 118, 120 as described above with respect to FIG. 1. In some implementations, the search browser, and/or other applications 118,120 can invoke one or more deep links for processing using new intent filters 202. For example, a given deep link can direct a user application to a search application.

Additionally or alternatively, automated assistant 116 can invoke a deep link for processing by new intent filters 202; automated assistant 116 can call a service for processing by new service 208; and/or automated assistant 116 can invoke one or more low level actions for processing by a new API for low level actions 220.

In some implementations, the new intent filters 202 processes the new deep link (e.g., from automated assistant 116, search browser and/or other applications 118, 120, etc.) and identifies a new activity 204 performable by the user application 104. For example, the new activity 204 can be to add an item to a list. In some implementations, once the new activity 204 is identified the system can fetch one or more available scripts 206 (e.g., from the script execution engine) to determine whether one or more of the available scripts 206 can perform the new activity 204. If one or more available scripts 206 can perform the new activity 204, the one or more available scripts 206 are executed by the script execution engine 106 prior to, and/or in-line with, execution (i.e., performance) of the new activity 204.

In some implementations, the new activity 204 can be determined to be part of an existing main activity 210 of the user application 104 (e.g., the new activity 204 can be an update to the existing main activity 210 of the user application 104). In some of those implementations, the script execution engine 106 can execute one-or more low level actions to perform the existing main activity 210. Additionally or alternatively, the script execution engine 106 can execute one or more low level actions to perform one or more other existing activities 214. In some implementations, the script execution engine 106 can additionally or alternatively provide output via a display device to inform the user of action(s) being performed by the script execution engine 106 and/or to provide update(s) on the execution of the activity via script execution UI 216.

Additionally or alternatively, the automated assistant 116 can call a service which can be identified as a new service 208. In some implementations, the new service 208 can be executed via an existing script by the script execution engine 106. Additionally or alternatively, the system can execute the new service 208 by executing one or more low level actions. For example, the new service 208 can be executed with one or more low level actions as a foreground activity 218. In some versions of those implementations, the foreground activity 218 can utilize a new API for low level actions 220 during execution. In some other implementations, the automated assistant 116 can directly invoke the low-level action using a new API for low level actions 220.

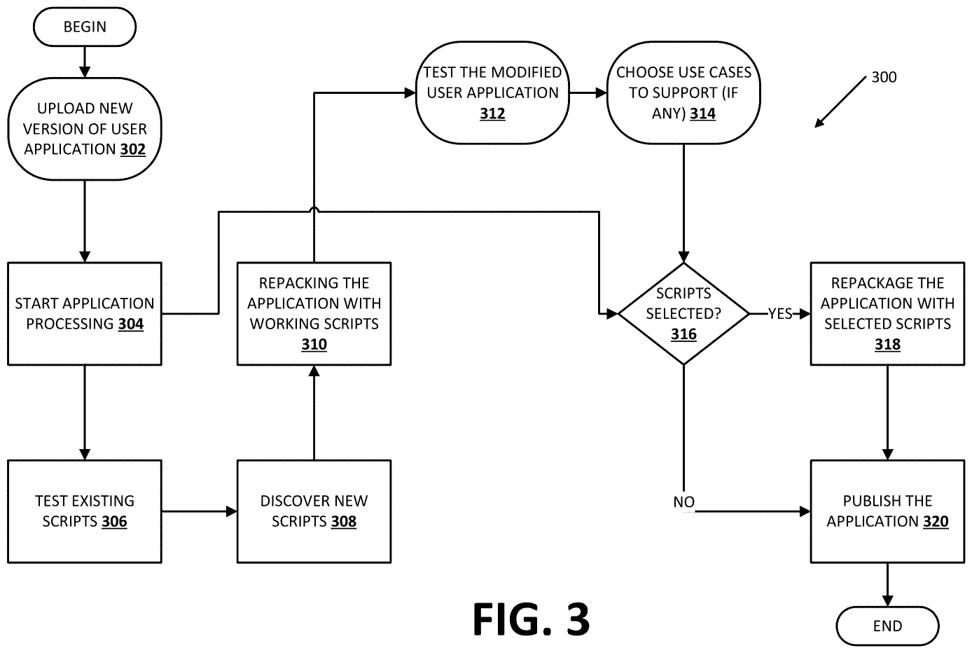

FIG. 3 illustrates an example 300 of integrating a script execution engine into a new version of a user application in accordance with various implementations. In the illustrated example, the in-app automation system is automatically generating scripts for an updated version of an existing user application. However, this is not meant to be limiting. Additional or alternative implementations of in-app automation are directed towards automatically generating scrips for a new user application (e.g., without a previous version of the application). At step 302, a developer can upload the new version of the user application 302.

For example, the developer can upload version 2.0 of ‘Hypothetical User Application,’ where ‘Hypothetical User Application’ has a previous version 1.0. After publishing version 2.0 of ‘Hypothetical User Application,’ the in-app automation system needs to generate, discover, and/or otherwise validate the scripts for any supported tasks. In some implementations, the in-app automation system needs to get developer consent for integrating specific scripts into ‘Hypothetical User Application.’ In some other implementations, the in-app automation system gets consent from the developer to automate any task the system is capable of. In some versions of those implementations, the in-app automation system requests consent from the developer to automate tasks within the user application at any time. This allows the in-app automation system to provide scripts for tasks without needing all the scripts generated at the time the user uploads the new version of the user application. However, allowing the scripts to be dynamically downloaded to the user application may pose additional security concerns.

At step 304, the system can start processing version 2.0 of ‘Hypothetical User Application’ using the in-app automation system. For example, at step 306, the system can test existing scripts for version 1.0 of ‘Hypothetical User Application’. In some implementations, the existing scripts can be generic scripts and/or application specific scripts which work with version 1.0 of the user application. Additionally or alternatively, at step 308, the in-app automation system can discover new scripts for version 2.0 of ‘Hypothetical User Application’. At step 310, the in-app automation system can repack version 2.0 of ‘Hypothetical User Application’ with working existing scripts and/or working new scripts.

At step 312, the application developer has the opportunity to test and review the updated version of the user application (e.g., version 2.0 of ‘Hypothetical User Application’ after the working existing scripts and/or working new scripts are integrated into the application). Additionally or alternatively, at step 314, the application developer (or other user of the in-app automation system) can select tasks which can be automatically performed with the working existing scripts and/or working new scripts.

At step 316, the system can determine whether the developer has selected one or more scripts to support for version 2.0 of ‘Hypothetical User Application’. In some implementations, the system can determine there are no scripts at step 304 when the system starts processing the user application. In some other implementations, the system can determine there are no scripts selected based on the application developer not selecting any scripts at step 314 to support. If the system determines no scripts have been added, the system can proceed to publishing the application at step 320. Additionally or alternatively, if the system determines that one or more scripts have been added by the application developer at step 314, the system can proceed to repacking version 2.0 of ‘Hypothetical User Application’ with the selected scripts at step 310.

In some implementations, the developer can grant the in-app automation system permission to dynamically download additional scripts to perform tasks as they are created. However, new versions of user applications are frequently updated with only minor changes and/or bug fixes. Where only minor changes are made to a user application, it is likely that script(s) from the previous version will continue working. In some of those implementations, the system can package the latest available version of each script inside the newly published version of the user application without the in-app automation system validating the script(s). Additionally or alternatively, the in-app automation system can generate one or more new scripts for a user application offline (e.g., generate one or more new scripts while a developer is not publishing a new version of the user application) and to be integrated into a future version of the user application.

In some implementations, the in-app automation system can include an in-app demotion system for when one or more specific scripts begin failing (e.g., failing based on changes in an updated version of the user application). The in-app demotion system can cause the removal or downgrading of scripts that begin to fail. For example, the system can downgrade a script once it fails a threshold number of times (e.g., 100 times, 1000 times, etc.), and/or after a threshold amount of time (e.g., 3 months, 2 weeks, etc.) has elapsed since the script was last run. Additionally or alternatively, the developer can request to downgrade one or more specific scripts at any point in time.

Additionally or alternatively, the in-app automation system can be used to generate new scripts which can be integrated into the user application as a sub-version update (with developer consent). The sub-version update allows a developer to consent to new scripts being integrated into the user application as part of the sub-version update without direct developer involvement.

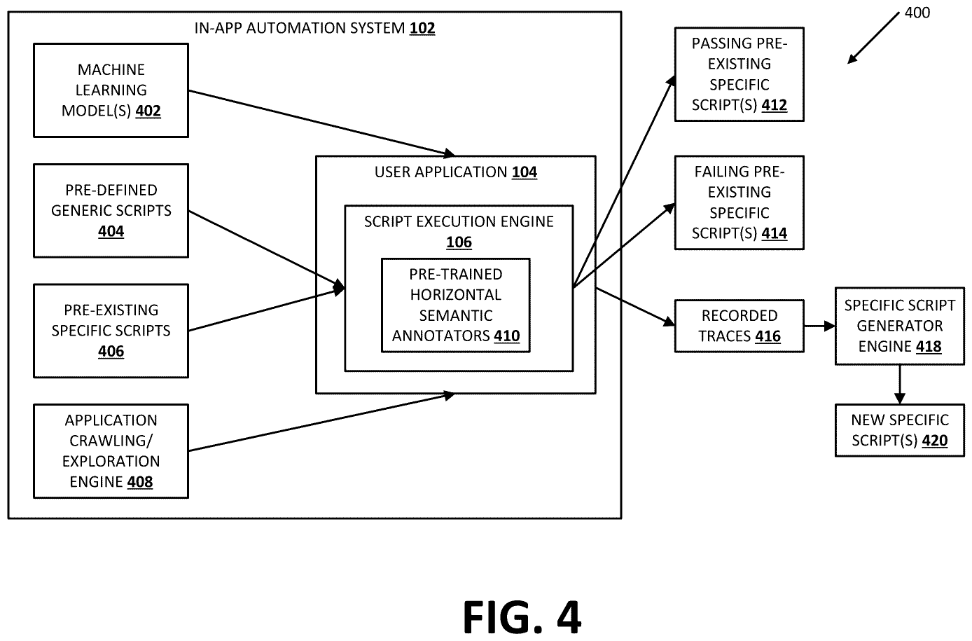

FIG. 4 illustrates an example 400 of automatically generating scripts for a given user application in accordance with various implementations. Example 400 includes an in-app automation system 102, a user application 104, and a script execution engine 106 as described above with respect to FIG. 1. In some implementations, the user application 104 includes the script execution engine 106, one or more pre-trained horizontal semantic annotators 410, one or more additional scripts (not depicted), one or more additional or alternative components, and/or combinations thereof. Additionally or alternatively, example 400 includes one or more ML models 402, one or more predefined generic scripts 404, one or more pre-existing specific scripts 406, and/or an application crawling/exploration engine 408.

Machine learning models (e.g., complex machine learning models) cannot be used during script execution due to size limitations, latency limitations, privacy limitations, etc. However, complex machine learning models can be used during script generation. For example, one or more ML models can be used in generating a script that uses simple constructs available to the script execution engine during execution (e.g., refer only to UI attributes which are available to the script execution engine during the execution of the script).

For example, existing ML model(s) 402 (such as an end-to-end ML model) can be adapted and/or retrained by the system for use in automatic script generation. Additionally or alternatively, custom ML model(s) can be trained for use in automatic script generation. In some implementations, the in-app automation system 102 can record traces 416 of actions performed by the script execution engine using the ML model(s) 402 as demonstrators. For example, a machine learning model (e.g., one or more of the existing ML model(s) 402 and/or custom ML model) can process a full screen representation (e.g., view hierarchy) of the user application and a semantic representation (e.g., task description) of a task to generate output indicating the next low level action for the user application. Additionally or alternatively, a machine learning model (e.g., one or more of the existing ML model(s) 402 and/or custom ML model) can process a full screen representation (e.g., view hierarchy) of the user application and a natural language description of the task being performed and/or the next step of the task being performed to generate output indicating the next low-level action for the user application.

The in-app automation system 102 can include a set of pre-defined generic scripts 404 which can be used to execute tasks in multiple user applications. In some implementations, the pre-defined generic scripts 404 can be used to execute tasks in multiple user applications. In some versions of those implementations, a pre-defined generic script includes one or more horizontal semantic annotators which are not application specific. A full and/or partial screen representation of the user application can be processed by the annotator to generate one or more semantic annotations. For example, a full and/or partial screen representation of the user application can be processed using an icon annotator to annotate one or more icons in the user application.

Additionally or alternatively, the in-app automation system 102 can include one or more pre-existing specific scripts 406 which can be used to execute tasks in the user application 104. In some implementations, the specific scripts can be pre-defined per task, can be working scripts for the previous version of the application, etc.

In some implementations, one or scripts can be generated using application crawling/exploration engine 408 based on user application exploration and/or application crawling to identify important states inside a given user application (e.g., named states) and ways to get to those states. In some implementations, the crawling and/or exploration can be used to generate recorded traces 416 of actions performed by the script execution engine, where the recorded trace(s) 416 can be processed using specific script generator engine 418 to generate one or more new specific scripts 420. Additionally or alternatively, the one or more recorded traces 416 can be processed to generate one or more generic scripts (not depicted) for use in executing generic tasks.

In some implementations, the script execution engine 106 includes one or more pre-trained horizontal semantic annotators 410. A full screen representation of the user application (e.g., a view hierarchy, an accessibility tree, a screen shot capturing the user application, one or more additional or alternative representations of the user application, etc.) can be processed using the annotator(s) to identify one or more semantic annotations. For example, a full screen representation of the user application can be processed using an icon annotator to annotate one or more icons in the user application. In some versions of those implementations, each implementation of the script execution engine 106 can include a generic set of pre-trained horizontal semantic annotators 410 to perform a set of common actions commonly performed within user applications (e.g., adding an item to a list, searching within the user application, etc.). For example, the script execution engine 106 can include the top 10 most frequently used pre-trained horizontal semantic annotators 410 representing the top 10 most commonly performed generic actions of any user applications.

In some implementations, the in app automation system 102 can determine whether pre-existing scripts (e.g., pre-defined generic scripts 404, pre-existing specific scripts 406, one or more additional or alternative scripts) can be executed to perform a task for the user application 104. The in-app automation system can determine whether a given pre-existing script can be executed by the script execution engine 106 and identify it as a passing pre-existing specific script 412. If the in-app automation system determines that a pre-existing script cannot be executed by the script execution engine 106, the system can identify it as a failing pre-existing specific script 414.

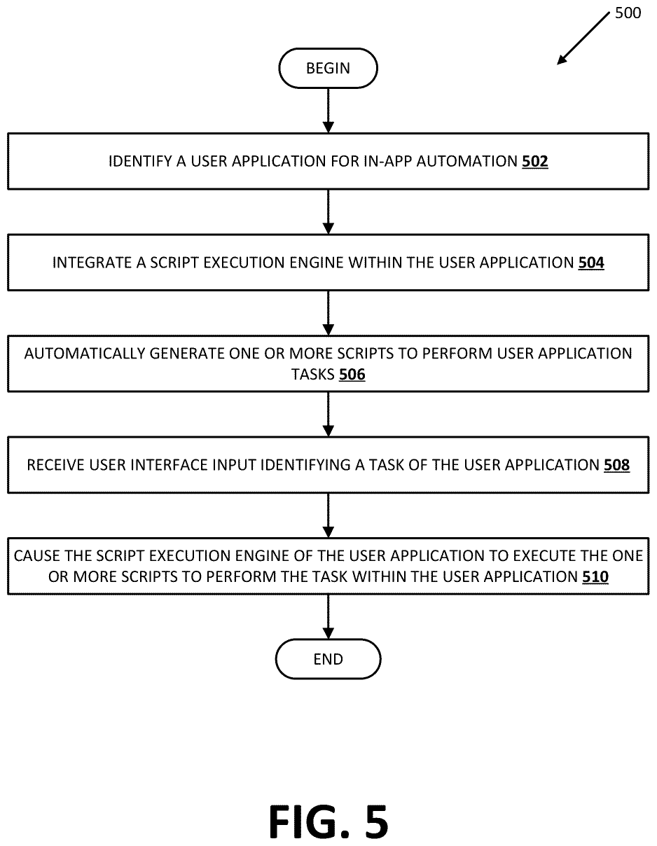

FIG. 5 is a flowchart depicting an example process 500 in accordance with various implementations. For convenience, the operations of the process 500 are described with reference to a system that performs the operations. This system may include various components of various computer systems, such as one or more components of client device 702, client device 802, and/or computing system 910. Moreover, while operations of process 500 are shown in a particular order, this is not meant to be limiting. One or more operations may be reordered, omitted, and/or added.

At block 502, the system identifies a user application for in-app automation. In some implementations, the user application is a new application (e.g., not currently available for download in an application store). For example, the system can identify ‘Hypothetical New Application’ for in-app automation, where ‘Hypothetical New Application’ was not currently available for download in an application store. In some other implementations, the user application is a new version of an existing application (e.g., an updated version of an application currently available for download in an application store). For example, the system can identify version 2.0 of ‘Hypothetical User Application’ for in-app automation, where version 1.0 of ‘Hypothetical User Application’ is currently available for download in an application store. In some implementations, the user application can be a first party (1P) application. Additionally or alternatively, the user application can be a third party (3P) application.

At block 504, the system integrates a script execution engine into the user application. In some implementations, the script execution engine is included in the user application via a software development kit (SDK). For example, the application developer can include the script execution engine in ‘Hypothetical User Application’ with an SDK. In some other implementations, the script execution engine is injected into the user application (with the developer consent) when the developer uploads the user application and/or an update to the user application to the application store. For example, the script execution engine can be automatically injected into the user application (with the developer consent) when the developer uploads version 2.0 of ‘Hypothetical User Application’ to the application store. In some implementations, the script execution engine can be script execution engine 106 as described herein.

At block 506, the system automatically generates one or more scripts for the user application. In some implementations, the one or more scripts perform one or more user application tasks for the identified user application. In some implementations, the system can automatically generate script(s) as described herein with respect to FIG. 2.

At block 508, the system receives user interface input that includes at least an instruction to perform a given task via the user application. In some implementations, the user interface input can be natural language input such as audio data capturing a spoken utterance of a user of the application (e.g., audio data which includes an instruction of “add eggs to my shopping list”). Additionally or alternatively, the user interface input can include text-based user input.

At block 510, the system causes the script execution engine of the user application to execute the one or more scripts to perform the task within the user application.

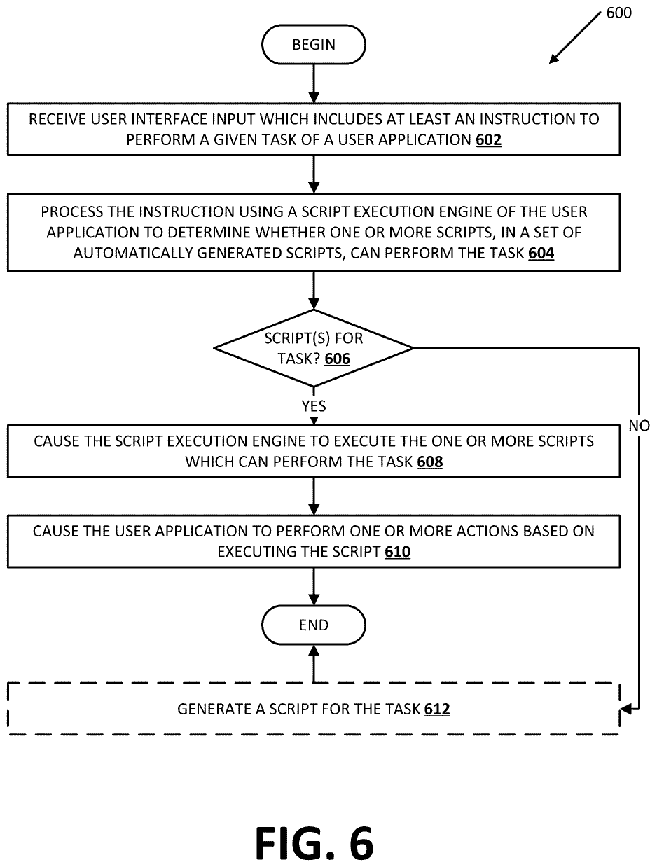

FIG. 6 is a flowchart depicting an example process 600 in accordance with various implementations. For convenience, the operations of the process 600 are described with reference to a system that performs the operations. This system may include various components of various computer systems, such as one or more components of client device 702, client device 802, and/or computing system 910. Moreover, while operations of process 600 are shown in a particular order, this is not meant to be limiting. One or more operations may be reordered, omitted, and/or added.

At block 602, the system receives user interface input which includes at least an instruction to perform a given task of a user application. For example, the system can receive audio data capturing a spoken utterance of “add eggs to my grocery shopping list,” where the task is to ‘add eggs’ to a grocery shopping list of ‘Hypothetical List Application.’ Additionally or alternatively, the user interface input can include text-based user input, selection of a visual element, and/or one or more additional or alternative types of user interface input. In some implementations, the system can process the user interface input using an automated assistant, a generative model, one or more additional or alternative natural language processing components, and/or combinations thereof. In some versions of those implementations, the system can generate output indicating the user application and the instruction (e.g., NL text based output, additional or alternative output, and/or combinations thereof).

At block 604, the system processes the instruction using a script execution engine of the user application to determine whether one or more scripts, in a set of automatically generated scripts, can perform the task for the user application. In some implementations, a given script of the set of automatically generated scripts corresponds to a sequence of application automation actions mapping to the one or more high level user application tasks. In some implementations, the script execution engine is integrated in the user application. For example, the script execution engine can be integrated into ‘Hypothetical List Application’ automatically (with the developer consent) while the developer is publishing the user application for download and/or by the developer of the application via an SDK. The script execution engine of ‘Hypothetical List Application’ can process the user interface input and/or output generated based on the user interface input to determine if there is a script to add items to a list integrated into ‘Hypothetical List Application’ to add eggs to a grocery shopping list.

At block 606, the system determines whether the set of automatically generated scripts include the one or more scripts which can perform the task for the user application. If so, the system proceeds to block 608 and causes the script execution engine to execute the one or more scripts which can perform the task. If the system determines the set of automatically generated scripts does not include one or more scripts which can perform the task for the user application, the system can optionally proceed to block 612 and automatically generate a script for the task (e.g., a script which can be used to execute the task based on subsequent user interface input including the instruction to perform the task). If the system does not generate a script for the task at block 612, the process ends.

At block 608, the system causes the script execution engine to execute the one or more scripts which can perform the task within the user application. In some implementations, executing the script causes the script execution engine to perform a sequence of application actions to perform the task. In some of those implementations, executing the script causes the script execution engine to interact with one or more user interface elements of the user application to perform the task. For example, the script execution engine can execute the script to add an item to a list in ‘Hypothetical List Application’, where executing the add an item to the list script causes the script execution engine to tap a user interface element corresponding to the grocery shopping list, tap on a user interface element corresponding to adding an item, and inserting the text “eggs” in a corresponding text box of the grocery shopping list.

At block 610, the system causes the user application to perform one or more actions based on the execution of the script. For example, the script execution engine can cause ‘Hypothetical List Application’ to perform the action of adding “eggs” to the grocery list.

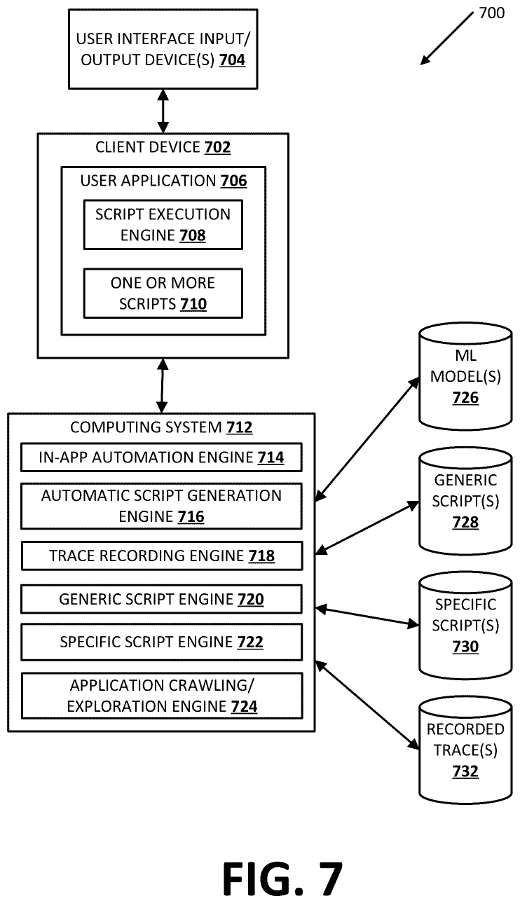

FIG. 7 is a block diagram of an example environment 700 that demonstrates various aspects of the present disclosure, and in which implementations disclosed herein can be employed. The example environment 700 includes client device 702, user interface input/output device(s) 704, computing system 712, one or more additional or alternative components (not depicted), and/or combinations thereof. The computing device 702 includes user application 706, one or more additional or alternative components (not depicted), and/or combinations thereof. The user application 706 includes script execution engine 708, one or more scripts 710, one or more additional or alternative components (not depicted), and/or combinations thereof. Computing system 712 includes in-app automation engine 714, automatic script generation engine 716, trace recording engine 718, generic script engine 720, specific script engine 722, application crawling/exploration engine 724, one or more additional or alternative components (not depicted), and/or combinations thereof. Additionally or alternatively, computing system 712 can include one or more machine learning models 726, one or more generic scripts 728, one or more specific scripts 730, one or more recorded traces 732, one or more additional or alternative components (not depicted), and/or combinations thereof.

In some implementations, client device 702, computing system 712, and/or additional or alternative components may communicate with one another via one or more communication networks, such as the Internet, a local area network, a wide area network, a virtual private network, etc. (not depicted). In some implementations, client device 702 and/or computing system 712 may include one or more of: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance, and/or a wearable apparatus of the user that includes a computing device (e.g., a watch of the user having a computing device, glasses of the user having a computing device, a virtual or augmented reality computing device). Additional and/or alternative client devices may be provided. Client device 702 may include one or more memory for storage of data and software applications, one or more processors for accessing data and executing applications, and other components that facilitate communication over the network. The operations performed by client device 702 may be distributed across multiple computer systems. For example, computing programs running on one or more computers in one or more locations can be coupled to each other through a network.

In some implementations, the computing device 702 can include one or more user interface input/output devices 704, which may include, for example, a physical keyboard, a touch screen (e.g., implementing a virtual keyboard or other textual input mechanism), a microphone, a camera, a display screen, one or more speakers, a haptic output, and/or additional or alternative input/output devices. The user interface input/output devices 704 may be incorporated into the client device 702 or may be separate. For example, a mobile phone of the user may include the user interface input/output devices 704, a first computing device may include the user interface input devices 704 and a separate computing device may include the user interface output devices 704, etc. In some implementations, all, or aspects of the client device 702 may be implemented on a computing system that also contains the user input/output devices 704.

In some implementations, client device 702 includes one or more user applications 706. While a single user application 706 is illustrated in FIG. 7, it is understood that multiple user applications 706 may be implemented on client device 702, e.g., by executing multiple threads on CPU(s) of client device 702. User application 706 can include a script execution engine 708, one or more scripts 710, and one or more additional or alternative components (not depicted). In some implementations, the script execution engine 708 is included in the user application 706 by the developer of the user application with a software development kit (SDK). In some other implementations, the script execution engine 708 is injected into the user application (with the developer consent) when the developer uploads the user application and/or an update to the user application to the application store. For example, the script execution engine 708 can be automatically injected into the user application 706 (with the developer consent) when the developer uploads version 2.0 of ‘Hypothetical User Application’ to the application store. In some implementations, the user application 706 can be a first party (1P) application. Additionally or alternatively, the user application 706 can be a third party (3P) application. In some implementations, script execution engine 708 can include an in-app demotion system (not depicted) for when one or more specific scripts begin failing (e.g., failing based on changes in an updated version of the user application).

Computing system 712 can utilize in-app automation engine 714 to integrate the script execution engine 708 into user application 706 (either with developer consent when publishing the application and/or with an SDK). In some implementations, the computing system 712 includes automatic script generation engine 716. In some versions of those implementations, the automatic script generation engine 716 can generate one or more scripts using trace recording engine 718, generic script engine 720, specific script engine 722, and/or application crawling/exploration engine 724. For example, the trace recording engine 718 can record traces of actions performed by script execution engine 708 when executing a script (e.g., executing the one or more sequences of actions specified by the script). In some implementations, the trace recording engine 718 can store the traces as one or more recorded traces 732.

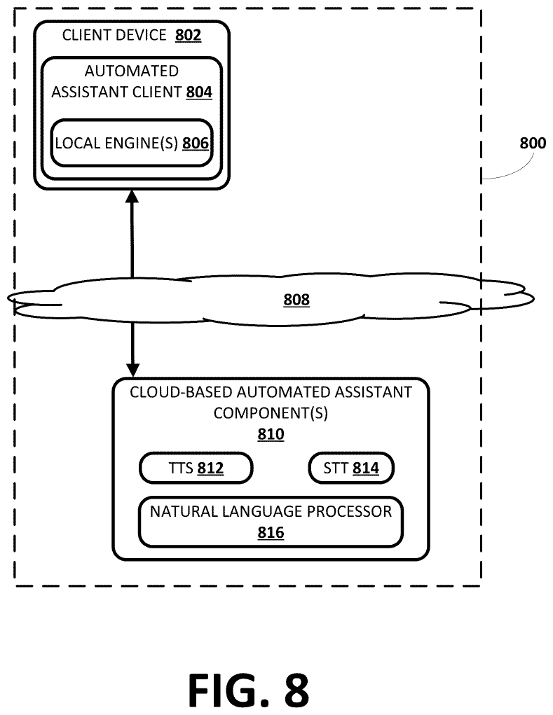

Turning now to FIG. 8, another example environment 800 is illustrated in which various implementations disclosed herein can be performed. FIG. 8 describes a client device 802 which executes the user application 804. One or more cloud-based automated assistant components 810 can be implemented on one or more computing systems (collectively referred to as a “cloud” computing system) that are communicatively coupled to client device 802 via one or more local and/or wide area networks (e.g., the Internet) indicated generally at 808.

An instance of an automated assistant client 804, by way of its interactions with one or more cloud-based automated assistant components 810, may form what appears to be, from the user's perspective, a logical instance of an automated assistant 800 with which the user may engage in a human—automated assistant conversation (e.g., a two-sided conversation). An instance of such an automated assistant 800 is depicted in FIG. 8. It thus should be understood that in some implementations, a user that engages with an automated assistant client 804 executing on client device 802 may, in effect, engage with his/her own logical instance of an automated assistant 800. For the sakes brevity and simplicity, the term “automated assistant” as used herein as “serving” a particular user will often refer to the combination of an automated assistant client 804 executing on a client device 802 operated by the user and one or more cloud-based automated assistant components 810 (which may be shared amongst multiple automated assistant clients 804 of multiple client devices). It should also be understood that in some implementations, automated assistant 800 may respond to a request from any user regardless of whether the user is actually “served” by that particular instance of automated assistant 800.

The client device 802 may be, for example: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided. In various implementations, the client device 802 may optionally operate one or more other applications that are in addition to automated assistant client 804, such as a message exchange client (e.g., SMS, MMS, online chat), a browser, and so forth. In some of those various implementations, one or more of the other applications can optionally interface (e.g., via an application programming interface) with the automated assistant 800, or include their own instance of an automated assistant application (that may also interface with the cloud-based automated assistant component(s) 810).

Automated assistant 800 engages in human-to-computer dialog sessions with a user via user interface input/output devices (not depicted) of the client device 802. To preserve user privacy and/or to conserve resources, in many situations a user must often explicitly invoke the automated assistant 800 before the automated assistant will fully process a spoken utterance. The explicit invocation of the automated assistant 800 can occur in response to certain user interface input received at the client device 802. For example, user interface inputs that can invoke the automated assistant 800 via client device 802 can optionally include actuations of a hardware and/or virtual button of client device 802. Moreover, the automated assistant client can include one or more local engines 806, such as an invocation engine that is operable to detect the presence of a spoken utterance and activate the on-device voice engines. The invocation engine can invoke the automated assistant 800 in response to detecting a spoken invocation phrase such as “Hey Assistant,” “OK Assistant”, and/or “Assistant”.

The invocation engine can continuously process (e.g., if not in an inactive mode) a stream of audio data frames that are based on output from one or more microphones of the client device 802, to monitor for an instance of the invocation phrase. While monitoring for the occurrence of the invocation phrase, the invocation engine discards (e.g., after temporary storage in a buffer) any audio data frames that do not include the spoken invocation phrase. However, when the invocation engine detects an instance of the spoken invocation phrase in processed audio data frames, the invocation engine can invoke the automated assistant 800. As used herein, “invoking” the automated assistant 800 can include causing one or more previously inactive functions of the automated assistant 800 to be activated. For example, invoking the automated assistant 800 can include causing one or more local engines 806 and/or cloud-based automated assistant components 810 to further process audio data frames based on which the invocation phrase was detected, and/or one or more following audio data frames (whereas prior to invoking no further processing of audio data frames was occurring). For instance, local and/or cloud-based components can process captured audio data using a two-pass ASR model in response to invocation of the automated assistant 800.

The one or more local engine(s) 806 of automated assistant 800 are optional, and can include, for example, the invocation engine described above, a local speech-to-text (“STT”) engine (that converts captured audio to text), a local text-to-speech (“TTS”) engine (that converts text to speech), a local natural language processor (that determines semantic meaning of audio and/or text converted from audio), and/or other local components. Because the client device 802 is relatively constrained in terms of computing resources (e.g., processor cycles, memory, battery, etc.), the local engines 806 may have limited functionality relative to any counterparts that are included in the cloud-based automated assistant component(s) 810.

Cloud-based automated assistant components 810 leverage the virtually limitless resources of the cloud to perform more robust and/or more accurate processing of audio data, and/or other user interface input, relative to any counterparts of the local engine(s) 806. Again, in various implementations, the client device 802 can provide audio data and/or other data to the cloud-based automated assistant component 810 in response to the invocation engine detecting a spoken invocation phrase or detecting some other explicit invocation of the automated assistant 800.

The illustrated cloud-based automated assistant components 810 include a cloud-based TTS module 812, a cloud-based STT module 814, a natural language processor 816, and/or one or more additional or alternative components (not depicted). In some implementations, one or more of the engines and/or modules of environment 800 may be omitted, combined, and/or implemented in a component that is separate from automated assistant 800. Further, in some implementations automated assistant 800 may include additional and/or alternative engines and/or modules. Cloud-based STT module 814 can convert audio data into text, which may then be provided to natural language processor 816.

Cloud-based TTS module 812 can convert textual data (e.g., natural language responses formulated by automated assistant 800) into computer-generated speech output. In some implementations, TTS module 812 may provide the computer-generated speech output to client device 802 to be output directly, e.g., using one or more speakers. In other implementations, textual data (e.g., natural language responses) generated by automated assistant 800 may be provided to one of the local engine(s) 806, which can then convert the textual data into computer-generated speech that is output locally.

Natural language processor 816 of automated assistant 800 processes free form natural language input and generates, based on the natural language input, annotated output for use by one or more other components of the automated assistant 800. For example, the natural language processor 816 can process natural language free form input that is textual input that is a conversion of spoken input, by STT module 814. The generated annotated output may include one or more annotations of the natural language input and optionally one or more (e.g., all) of the terms of the natural language input.

In some implementations, the natural language processor 816 is configured to identify and annotate various types of grammatical information in natural language input. In some implementations, the natural language processor 816 may additionally and/or alternatively include an entity tagger (not depicted) configured to annotate entity references in one or more segments such as references to people (including, for instance, literary characters, celebrities, public figures, etc.), organizations, locations (real and imaginary), and so forth. In some implementations, the natural language processor 816 may additionally and/or alternatively include a coreference resolver (not depicted) configured to group, or “cluster,” references to the same entity based on one or more contextual cues. For example, the coreference resolver may be utilized to resolve the term “there” to “Hypothetical Cafe” in the natural language input “I like Hypothetical Cafe last time we ate there.” In some implementations, one or more components of the natural language processor 816 may rely on annotations from one or more other components of the natural language processor 816. In some implementations, in processing a particular natural language input, one or more components of the natural language processor 816 may use related prior inputs and/or other related data outside of the particular natural language input to determine one or more annotations.

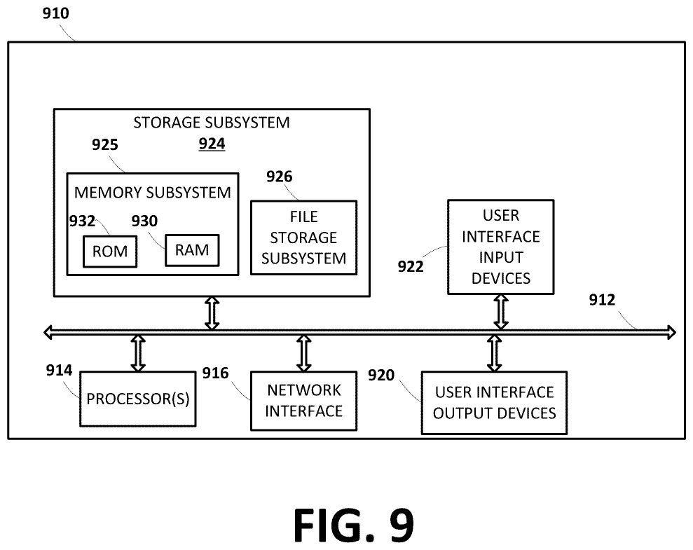

FIG. 9 is a block diagram of an example computing device 910 that may optionally be utilized to perform one or more aspects of techniques described herein. In some implementations, one or more of a client computing device, and/or other component(s) may comprise one or more components of the example computing device 910.

Computing device 910 typically includes at least one processor 914 which communicates with a number of peripheral devices via bus subsystem 912. These peripheral devices may include a storage subsystem 924, including, for example, a memory subsystem 925 and a file storage subsystem 926, user interface output devices 920, user interface input devices 922, and a network interface subsystem 916. The input and output devices allow user interaction with computing device 910. Network interface subsystem 916 provides an interface to outside networks and is coupled to corresponding interface devices in other computing devices.

User interface input devices 922 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 910 or onto a communication network.

User interface output devices 920 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 910 to the user or to another machine or computing device.

Storage subsystem 924 stores programming and data constructs that provide the functionality of some or all of the modules described herein. For example, the storage subsystem 924 may include the logic to perform selected aspects of the processes described herein.

These software modules are generally executed by processor 914 alone or in combination with other processors. Memory 925 used in the storage subsystem 924 can include a number of memories including a main random access memory (RAM) 930 for storage of instructions and data during program execution and a read only memory (ROM) 932 in which fixed instructions are stored. A file storage subsystem 926 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 926 in the storage subsystem 924, or in other machines accessible by the processor(s) 914.

Bus subsystem 912 provides a mechanism for letting the various components and subsystems of computing device 910 communicate with each other as intended. Although bus subsystem 912 is shown schematically as a single bus, alternative implementations of the bus subsystem may use multiple buses.

Computing device 910 can be of varying types including a workstation, server, computing cluster, blade server, server farm, or any other data processing system or computing device. Due to the ever-changing nature of computers and networks, the description of computing device 910 depicted in FIG. 9 is intended only as a specific example for purposes of illustrating some implementations. Many other configurations of computing device 910 are possible having more or fewer components than the computing device depicted in FIG. 9.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, the method includes receiving user interface input which includes at least an instruction for a user application to perform a given task, wherein the user application is stored locally at a client device. In some implementations, the method includes processing the instruction using a script execution engine of the user application to determine whether an automatically generated script of a set of automatically generated scripts can perform the given task, wherein the automatically generated script of the set of automatically generates scripts includes a sequence of application automation actions to perform the given task of the user application, and wherein the automatically generated script was generated prior to receiving the user interface input. In some implementations, in response to determining the automatically generated script can perform the task, the method includes executing the automatically generated script using the execution engine of the user application to perform the given task. In some implementations, the method includes causing the user application to perform one or more actions based on the execution of the automatically generated script.

These and other implementations of the technology can include one or more of the following features.

In some implementations, the automatically generated script was generated prior to receiving the user interface input. In some versions of those implementations, generating the automatically generated script includes identifying a set of predefined generic scripts which are not specifically generated for the given user application. In some implementations, the method further includes processing the set of predefined generic scripts using the script application engine of the user application to determine whether each predefined generic script can be executed to perform a task for the user application. In some implementations,
in response to determining whether each predefined generic script can be executed to perform the task for the user application, including each of the predefined generic scripts which can be executed to perform the task for the user application as an automatically generated script.

In some implementations, a given predefined generic script in the set of predefined generic scripts includes one or more horizontal semantic annotators.

In some implementations, the automatically generated script was generated prior to receiving the user interface input, and wherein generating the automatically generated script includes identifying one or more previous scripts corresponding to a previous version of the user application, wherein the user application is a version subsequent to the previous version of the application. In some implementations, the method further includes processing the one or more previous scripts using the script execution engine of the user application to determine whether the one or more previous scripts can be executed to perform a task for the user application. In some implementations, in response to determining the one or more previous scripts can be executed to perform a task for the user application, the method further includes including each of the previous scripts which can be executed to perform a task for the user application as an automatically generated script.

In some implementations, the automatically generated script was generated prior to receiving the user interface input, and wherein generating the automatically generated script includes capturing a set of traces of the user application, where each trace includes a set of actions performed during the execution of a training task of the user application, and where the set of actions are demonstrated by a machine learning model. In some implementations, the method further includes generating one or more automatically generated scripts based on processing the set of traces. In some versions of those implementations, a given trace, in the set of traces of the user application, captures a (1) a semantic representation of the training task and (2) a sequence of full screen representations of the user application during execution of the training task. In some versions of those implementations, a given trace, in the set of traces of the user application, captures a (1) a natural language representation of the training task and (2) a sequence of full screen representations of the user application during execution of the training task.

In some implementations, the script execution engine of the user application is included in the user application via a software development kit.

In some implementations, the script execution engine of the user application is injected into the user application when a developer of the user application publishes the user application and/or an updated version of the user application.

In some implementations, a method implemented by one or more processors is provided, the method includes automatically generating a script for a user application, wherein the script includes a sequence of application automation actions to perform a given task of the user application. In some implementations, automatically generating the script includes processing one or more preexisting scripts to determine whether the one or more preexisting scripts can be executed to perform the given task for the user application and/or generating one or more new scripts for the user application. In some implementations, in response to determining whether the one or more preexisting scripts and/or the one or more new scripts can be executed to perform the given task for the user application, the method includes including the one or more preexisting scripts and/or the one or more new scripts which in a script execution engine of the user application. In some implementations, the method includes publishing the user application which includes the script execution engine and the one or more preexisting scripts and/or the one or more new scripts.

These and other implementations of the technology can include one or more of the following features.

In some implementations, processing the one or more preexisting scripts to determine whether the one or more preexisting scripts can be executed to perform the given task for the user application includes identifying a set of predefined generic scripts which are not specifically generated for the user application. In some implementations, the method includes processing the set of predefined generic scripts using the script execution engine of the user application to determine whether each predefined generic script can be executed to perform a task for the user application. In some implementations, in response to determining whether each predefined generic script can be executed to perform the task for the user application, the method includes including the one or more predefined generic scripts in the script execution engine of the user application. In some versions of those implementations, a given predefined generic script in the set of predefined generic scripts includes one or more horizontal semantic annotators. In some versions of those implementations, processing the one or more preexisting scripts to determine whether the one or more preexisting scripts can be executed to perform the given task for the user application includes identifying one or more previous scripts corresponding to a previous version of the user application, wherein the user application is a version subsequent to the previous version of the application. In some implementations, the method includes processing the one or more previous scripts using the script execution engine of the user application to determine whether the one or more previous scripts can be executed to perform a task for the user application. In some implementations, in response to determining the one or more previous scripts can be executed to perform a task for the user application, the method includes including the one or more previous scripts in the script execution engine of the user application.

In some implementations, generating the one or more new scripts for the user application includes capturing a set of traces of the user application, where each trace includes a set of actions performed during the execution of a training task of the user application, wherein the set of actions are demonstrated by a machine learning model. In some implementations, the method further includes generating the one or more new scripts based on processing the set of traces. In some versions of those implementations, a given trace, in the set of traces of the user application, captures a (1) a semantic representation of the training task and (2) a sequence of full screen representations of the user application during execution of the training task. In some versions of those implementations, a given trace, in the set of traces of the user application, captures a (1) a natural language representation of the training task and (2) a sequence of full screen representations of the user application during execution of the training task.

In some implementations, the script execution engine of the user application is included in the user application via a software development kit.

In some implementations, the script execution engine of the user application is injected into the user application when a developer of the user application publishes the user application and/or an updated version of the user application.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer readable storage media (e.g., transitory, or non-transitory) storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving user interface input which includes at least an instruction for a user application to perform a given task, wherein the user application is stored locally at a client device;
processing the instruction using a script execution engine of the user application to determine whether an automatically generated script of a set of automatically generated scripts can perform the given task, wherein the automatically generated script of the set of automatically generates scripts includes a sequence of application automation actions to perform the given task of the user application, and wherein the automatically generated script was generated prior to receiving the user interface input;
in response to determining the automatically generated script can perform the task, executing the automatically generated script using the execution engine of the user application to perform the given task; and
causing the user application to perform one or more actions based on the execution of the automatically generated script.

2. The method of claim 1, wherein the automatically generated script was generated prior to receiving the user interface input, and wherein generating the automatically generated script comprises:
identifying a set of predefined generic scripts which are not specifically generated for the given user application;
processing the set of predefined generic scripts using the script application engine of the user application to determine whether each predefined generic script can be executed to perform a task for the user application; and
in response to determining whether each predefined generic script can be executed to perform the task for the user application, including each of the predefined generic scripts which can be executed to perform the task for the user application as an automatically generated script.

3. The method of claim 2, wherein a given predefined generic script in the set of predefined generic scripts includes one or more horizontal semantic annotators.

4. The method of claim 1, wherein the automatically generated script was generated prior to receiving the user interface input, and wherein generating the automatically generated script comprises:
identifying one or more previous scripts corresponding to a previous version of the user application, wherein the user application is a version subsequent to the previous version of the application;
processing the one or more previous scripts using the script execution engine of the user application to determine whether the one or more previous scripts can be executed to perform a task for the user application;
in response to determining the one or more previous scripts can be executed to perform a task for the user application, including each of the previous scripts which can be executed to perform a task for the user application as an automatically generated script.

5. The method of claim 1, wherein the automatically generated script was generated prior to receiving the user interface input, and wherein generating the automatically generated script comprises:
capturing a set of traces of the user application, where each trace includes a set of actions performed during the execution of a training task of the user application, and where the set of actions are demonstrated by a machine learning model ; and
generating one or more automatically generated scripts based on processing the set of traces.

6. The method of claim 5, wherein a given trace, in the set of traces of the user application, captures a (1) a semantic representation of the training task and (2) a sequence of full screen representations of the user application during execution of the training task.

7. The method of claim 5, wherein a given trace, in the set of traces of the user application, captures a (1) a natural language representation of the training task and (2) a sequence of full screen representations of the user application during execution of the training task.

8. The method of claim 1, wherein the script execution engine of the user application is included in the user application via a software development kit.

9. The method of claim 1, wherein the script execution engine of the user application is injected into the user application when a developer of the user application publishes the user application and/or an updated version of the user application.

10. A method implemented by one or more processors, the method comprising:
automatically generating a script for a user application, wherein the script includes a sequence of application automation actions to perform a given task of the user application, and wherein automatically generating the script comprises:
processing one or more preexisting scripts to determine whether the one or more preexisting scripts can be executed to perform the given task for the user application and/or generating one or more new scripts for the user application;
in response to determining whether the one or more preexisting scripts and/or the one or more new scripts can be executed to perform the given task for the user application, including the one or more preexisting scripts and/or the one or more new scripts which in a script execution engine of the user application; and
publishing the user application which includes the script execution engine and the one or more preexisting scripts and/or the one or more new scripts.

11. The method of claim 10, wherein processing the one or more preexisting scripts to determine whether the one or more preexisting scripts can be executed to perform the given task for the user application comprises:
identifying a set of predefined generic scripts which are not specifically generated for the user application;
processing the set of predefined generic scripts using the script execution engine of the user application to determine whether each predefined generic script can be executed to perform a task for the user application; and
in response to determining whether each predefined generic script can be executed to perform the task for the user application, including the one or more predefined generic scripts in the script execution engine of the user application.

12. The method of claim 11, wherein a given predefined generic script in the set of predefined generic scripts includes one or more horizontal semantic annotators.

13. The method of claim 10, wherein processing the one or more preexisting scripts to determine whether the one or more preexisting scripts can be executed to perform the given task for the user application comprises:
identifying one or more previous scripts corresponding to a previous version of the user application, wherein the user application is a version subsequent to the previous version of the application;
processing the one or more previous scripts using the script execution engine of the user application to determine whether the one or more previous scripts can be executed to perform a task for the user application;
in response to determining the one or more previous scripts can be executed to perform a task for the user application, including the one or more previous scripts in the script execution engine of the user application.

14. The method of claim 10, wherein generating the one or more new scripts for the user application comprises:
capturing a set of traces of the user application, where each trace includes a set of actions performed during the execution of a training task of the user application, wherein the set of actions are demonstrated by a machine learning model; and
generating the one or more new scripts based on processing the set of traces.

15. The method of claim 14, wherein a given trace, in the set of traces of the user application, captures a (1) a semantic representation of the training task and (2) a sequence of full screen representations of the user application during execution of the training task.

16. The method of claim 14, wherein a given trace, in the set of traces of the user application, captures a (1) a natural language representation of the training task and (2) a sequence of full screen representations of the user application during execution of the training task.

17. The method of claim 10, wherein the script execution engine of the user application is included in the user application via a software development kit.

18. The method of claim 10, wherein the script execution engine of the user application is injected into the user application when a developer of the user application publishes the user application and/or an updated version of the user application.

19. A client device, comprising:
one or more processors; and
memory storing instructions that, when executed by the one or more processors, cause the one or more processors to perform operations, the operations comprising:
receiving user interface input which includes at least an instruction for a user application to perform a given task, wherein the user application is stored locally at the client device;
processing the instruction using a script execution engine of the user application to determine whether an automatically generated script of a set of automatically generated scripts can perform the given task, wherein the automatically generated script of the set of automatically generates scripts includes a sequence of application automation actions to perform the given task of the user application, and wherein the automatically generated script was generated prior to receiving the user interface input;
in response to determining the automatically generated script can perform the task, executing the automatically generated script using the execution engine of the user application to perform the given task; and
causing the user application to perform one or more actions based on the execution of the automatically generated script.
